(19) United States
(12) Patent Application Publication
(10) Pub. No.: US 2021/0063035 A1
(43) Pub. Date: Mar. 4, 2021

(54) HEAT EXCHANGE ELEMENT, HEAT EXCHANGE VENTILATOR, AND METHOD FOR MANUFACTURING HEAT EXCHANGE ELEMENT

(71) Applicant: Mitsubishi Electric Corporation, Tokyo (JP)

(72) Inventors: Akinori SHIMIZU, Tokyo (JP); Yasuhiro NAKAMURA, Tokyo (JP); Akane NOMURA, Tokyo (JP); Yoko MATSUURA, Tokyo (JP); Yoshihiro HOSOKAWA, Tokyo (JP); Hajime SOTOKAWA, Tokyo (JP); Takahiro KAWASAKI, Tokyo (JP)

(73) Assignee: Mitsubishi Electric Corporation, Tokyo (JP)

(21) Appl. No.: 17/043,697

(22) PCT Filed: Apr. 26, 2018
(86) PCT No.: PCT/JP2018/017061

§ 371 Date: Sep. 30, 2020

(51) Int. Cl. F24F 7/08; F28D 9/00

(52) U.S. Cl. CPC F24F 7/08; F24F 13/10; F28D 9/0062

(57) ABSTRACT

A heat exchange element includes a countercurrent portion including a plurality of partition plates each having a planar shape and a plurality of spacer plates each having a corrugated shape in cross section. The partition plates and spacer plates are alternately stacked such that corrugation directions of the spacer plates are aligned. A side surface of the countercurrent portion is formed by end portions defined by bending portions in each of which the partition plate and the spacer plate are overlaid. Since the heat exchange element according to the embodiment of the present disclosure is configured as described above, the heat insulation between flow paths of the heat exchange element and the outside air is improved, and heat exchange between fluid in the flow paths of the heat exchange element and the outside air is reduced. Consequently, the heat exchange element achieves improved heat exchange efficiency.

### TECHNICAL FIELD

The present disclosure relates to a heat exchange element for use in a heat exchange ventilator and an air-conditioning apparatus, and a method for manufacturing the heat exchange element.

### BACKGROUND ART

In recent years, heat exchange ventilators have been used as apparatuses for ventilating rooms, from the viewpoint of energy saving. A heat exchange ventilator is an apparatus that performs ventilation by exchanging the temperature and humidity (referred to collectively as “total heat”) inside the room and the temperature and humidity (referred to collectively as “total heat”) outside the room, using a heat exchange element. In order to reduce the heat loss due to ventilation, a paper unit that allows transmission of water vapor has been used. Also, in order to increase the heat exchange efficiency, a countercurrent heat exchange element has been used in which the air taken from the outside to the inside of the room and the exhaust air from the inside to the outside of the room flow in opposite directions.

A heat exchange element disclosed in Patent Literature 1 is known as a related-art countercurrent heat exchange element, in which heat transfer bodies, each having a flow path for an air flow formed by attaching a corrugated spacer plate to a partition plate made of thin paper for separating two fluids that transfer heat therebetween are stacked such that the flow paths are disposed parallel to each other, thereby forming a countercurrent portion having a corrugated structure.

In the heat exchange element of Patent Literature 1, the tips of the corrugations of the spacer plate are bonded to the planar surface of the partition plate, so that the corrugated spacer plate is bonded in line contact with the planar partition plate. Therefore, if the paper material is deformed even slightly, a gap may be formed between the partition plate and the spacer plate. As a result, fluid in the flow path leaks, through the gap, in the direction orthogonal to the flow path. In view of this problem, Patent Literature 2 discloses a heat exchange block that is obtained by forming a heat transfer body by bending the both ends of a partition plate to wrap around a spacer plate, and stacking plural of the heat transfer bodies.

### CITATION LIST

### Patent Literature

Patent Literature 1: Japanese Unexamined Patent Application Publication No. 2008-151424

Patent Literature 2: Japanese Unexamined Utility Model Registration Application Publication No. 57-46268

### SUMMARY OF INVENTION

### Technical Problem

According to the heat exchange block of Patent Literature 2, due to the configuration described above, it is expected that leakage of fluid to the outside can be prevented. On the other hand, at the side surface of the heat exchange block, heat is transferred between fluid in the flow paths and the outside air outside the heat exchange block through the bent portions of the partition plates, so that the heat exchange efficiency is reduced.

An object of the present disclosure is to solve the above problems, and to provide a heat exchange element having improved heat exchange efficiency, a heat exchange ventilator, and a method for manufacturing the heat exchange element.

### Solution to Problem

A heat exchange element according to an embodiment of the present disclosure includes: a countercurrent portion including a plurality of partition plates each having a planar shape, and a plurality of spacer plates each having a corrugated shape in cross section, the partition plates and spacer plates being alternately stacked such that corrugation directions of the spacer plates are aligned; wherein a side surface of the countercurrent portion is formed by end portions defined by bending portions in each of which the partition plate and the spacer plate are overlaid.

A method for manufacturing a heat exchange element according to another embodiment of the present disclosure includes: a heat transfer body forming step of forming a heat transfer body having a rectangular shape in plan view, by bonding a partition plate having a planar shape and a spacer plate having a corrugated shape in cross section; a stacking step of stacking plural heat transfer bodies; and a side surface forming step of bending portions in each of which the partition plate and the spacer plate are overlaid.

### Advantageous Effects of Invention

Since the heat exchange element according to the embodiment of the present disclosure is configured as described above, the heat insulation between the flow paths of the heat exchange element and the outside air is improved, and heat exchange between fluid in the flow paths of the heat exchange element and the outside air is reduced. Consequently, the heat exchange element achieves improved heat exchange efficiency.

### BRIEF DESCRIPTION OF DRAWINGS

FIG. 1 is a perspective view of a heat exchange element according to Embodiment 1 of the present disclosure.

FIG. 2 is a cross-sectional view taken along A-A′ of a countercurrent portion of the heat exchange element according to Embodiment 1 of the present disclosure.

FIG. 3 is an external top view of heat transfer bodies each used in a flow path change portion according to Embodiment 1 of the present disclosure.

FIG. 4 is an external top view of connected bodies each formed by bonding a heat transfer body used in the countercurrent portion and the heat transfer bodies used in the flow path change portion according to Embodiment 1 of the present disclosure.

FIG. 5 illustrates a partition plate and a spacer plate of the heat transfer body bonded to each other according to Embodiment 1 of the present disclosure.

FIG. 6 illustrates the partition plate and the spacer plate of the heat transfer body with both ends pressed according to Embodiment 1 of the present disclosure.

FIG. 7 is a cross-sectional view taken along A-A′ of a countercurrent portion of a heat exchange element according to Embodiment 2 of the present disclosure.

FIG. 8 is an external view illustrating a heat exchange ventilator installed in a room according to Embodiment 3 of the present disclosure.

FIG. 9 is an internal configuration diagram of the heat exchange ventilator according to Embodiment 3 of the present disclosure.

FIG. 10 is an internal configuration diagram of the heat exchange ventilator according to Embodiment 3 of the present disclosure.

FIG. 11 is a functional configuration diagram of the heat exchange ventilator according to Embodiment 3 of the present disclosure.

FIG. 12 is a flowchart illustrating the operation of a fan control unit of the heat exchange ventilator according to Embodiment 3 of the present disclosure.

FIG. 13 is a flowchart illustrating the operation of a damper control unit of the heat exchange ventilator according to Embodiment 3 of the present disclosure.

### DESCRIPTION OF EMBODIMENTS

### Embodiment 1

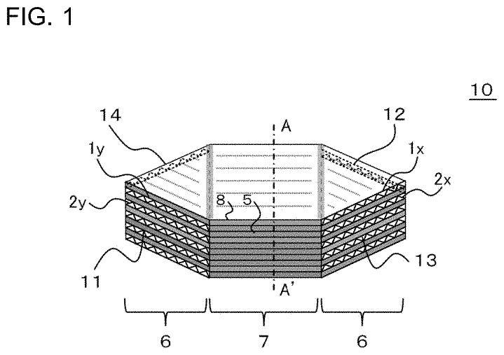

Hereinafter, the configuration of a heat exchange element 10 according to Embodiment 1 will be described with reference to FIGS. 1 to 6.

FIG. 1 is a perspective view of the heat exchange element 10 according to Embodiment 1. The heat exchange element 10 includes a flow path change portion 6 and a countercurrent portion 7. FIG. 2 is a cross-sectional view taken along A-A′ of the countercurrent portion 7 of the heat exchange element 10 according to Embodiment 1.

As illustrated in FIG. 2, the countercurrent portion 7 includes a plurality of partition plates 1 each having a planar shape, and a plurality of spacer plates 2 each having a corrugated shape in cross section. The partition plates 1 and the spacer plates 2 are alternately stacked such that the corrugation directions of the spacer plates 2 are aligned. That is, the countercurrent portion 7 is formed by stacking rectangular heat transfer bodies 3, each including the partition plate 1 having a planar shape and the spacer plate 2 having a corrugated shape in cross section, such that the corrugation directions of the spacer plates 2 are aligned.

As illustrated in FIG. 2, a first flow path 51 and a second flow path 52 are alternately formed in the spaces between the partition plates 1 of the adjacent heat transfer bodies 3. Air taken (first fluid) from the outside to the inside of the room flows through the first flow path 51. Air exhausted (second fluid) from the inside to the outside of the room flows through the second flow path 52. Since the first fluid flows through the first flow path 51 and the second fluid flows through the second flow path 52, the first fluid and the second fluid transfer heat via the partition plate 1.

Each side surface 5 of the countercurrent portion 7 is formed by end portions defined by bending portions in each of which the partition plate 1 and the spacer plate 2 are overlaid. Each spacer plate 2 forming the side surface 5 has a plurality of folds. Each fold of the spacer plate 2 forming the side surface 5 overlaps another portion of the spacer plate 2 forming the side surface 5. The partition plates 1 and the spacer plates 2 forming the side surface 5 are bonded by a bonding unit 9 (for example, a seal unit or an adhesive tape).

The partition plate 1 is a plate made of cellulose fibers, chitin, or other materials in order to improve the heat conductivity and transmissivity of water vapor. The spacer plate 2 is preferably thin. This is because, if the thickness is increased, the flow path is obstructed, resulting in an increase in pressure loss. Further, to retain the structure, the spacer plate 2 is preferably deformable by bending or other processing, and has the shape retention performance for retaining the deformed shape. The spacer plate 2 is a plate of a pulp material made of cellulose fibers or other materials, a resin plate, or a plate made of a metal (for example, aluminum, iron, and stainless).

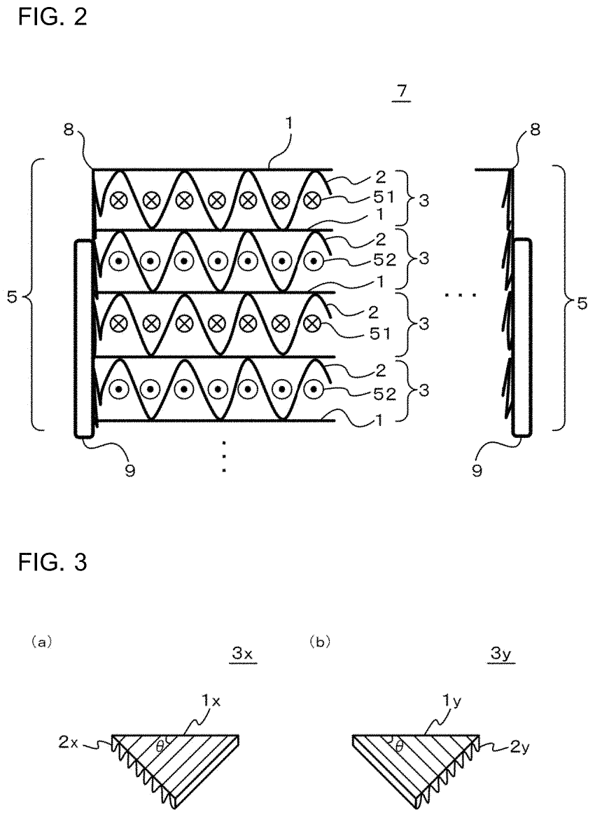

The flow path change portion 6 is formed by alternately stacking heat transfer bodies 3x and heat transfer bodies 3y each having the shape of an isosceles triangle. FIG. 3 is an external top view of the heat transfer body 3x and the heat transfer body 3y used in the flow path change portion 6 of the heat exchange element 10 according to Embodiment 1. Similar to the heat transfer body 3 described above, the heat transfer body 3x includes a partition plate 1x and a spacer plate 2x. The heat transfer body 3y includes a partition plate 1y and a spacer plate 2y. The heat transfer body 3x corresponds to the first flow path 51. The heat transfer body 3y corresponds to the second flow path 52.

The spacer plate 2x is bonded to the partition plate 1x to make an angle θ of 10 to 60 degrees to the base of the isosceles triangle. The spacer plate 2y is bonded to the partition plate 1y to make an angle θ of 10 relative to 60 degrees to the base of the isosceles triangle. The spacer plate 2x and the spacer plate 2y are bonded to the partition plate 1x and the partition plate 1y, respectively, so as not to have the first flow path 51 and the second flow path 52 oriented in the same direction.

The flow path change portion 6 changes the flow direction of the first fluid flowing through the first flow path 51 of the countercurrent portion 7, and the flow direction of the second fluid flowing through the second flow path 52. The first fluid that flows through the first flow path 51 flows from the outside into an inflow port 11 for the first fluid, and flows through the first flow path 51 in the flow path change portion 6 to the upper right in FIG. 1. Then, the first fluid flows through the first flow path 51 in the countercurrent portion 7 to the right in FIG. 1, flows through the first flow path 51 in the flow path change portion 6 to the upper right, and finally flows into the room from an outflow port 12 for the first fluid.

The second fluid that flows through the second flow path 52 flows from the room into an inflow port 13 for the second fluid, and flows through the second flow path 52 in the flow path change portion 6 to the upper left in FIG. 1. Then, the second fluid flows through the second flow path 52 in the countercurrent portion 7 to the left in FIG. 1, flows through the second flow path in the flow path change portion 6 to the upper left, and finally flows to the outside from an outflow port 14 for the second fluid.

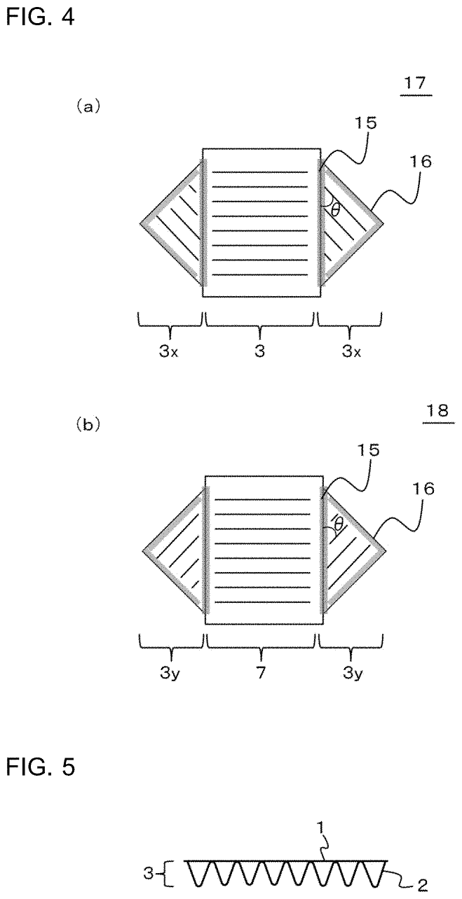

FIG. 4(a) is an external top view of the connected body 17 formed by bonding the heat transfer body 3 and the heat transfer bodies 3x of the heat exchange element 10 according to Embodiment 1. A bonding tape 15 is applied to the base of the isosceles triangle of each heat transfer body 3x. The same bonding tape 15 is applied to two of the sides of the rectangle of the partition plate 1 of the heat transfer body 3 located on the inflow port or the outflow port, so as to extend thereon. In this way, the connected body 17 including the heat transfer body 3 and the heat transfer bodies 3x is formed. In this step, the heat transfer body 3 and the heat transfer bodies 3x are bonded to each other such that the centers of corresponding sides are aligned.

FIG. 4(b) is an external top view of a connected body 18 formed by bonding the heat transfer body 3 and the heat transfer bodies 3y of the heat exchange element 10 according to Embodiment 1. As in the case of forming the connected body 17 described above, the bonding tape 15 is applied to the isosceles triangle of each heat transfer body 3y. The same bonding tape 15 is applied to two of the sides of the rectangle of the partition plate 1 of the heat transfer body 3 located on the inflow port or the outflow port, so as to extend thereon. In this way, the connected body 18 including the heat transfer body 3 and the heat transfer bodies 3y is formed. In this step, the heat transfer body 3 and the heat transfer bodies 3y are bonded to each other such that the centers of corresponding sides are aligned.

The portion in the connected body 17 where the bonding tape 15 is applied has a stacked structure of the spacer plate 2, the partition plate 1, and the bonding tape 15, and therefore is thicker by the thickness of the bonding tape 15 than the portion where the bonding tape 15 is not applied. The heat exchange element 10 is formed by alternately stacking the connected bodies 17 and the connected bodies 18.

When the connected body 17 and the connected body 18 are stacked, the bonding tape 15 of the connected body 17 and the spacer plate 2 of the connected body 18 are in contact with each other in the portion with the bonding tape 15. However, in the portion of the connected body 17 without the bonding tape 15, a gap corresponding to the thickness of the bonding tape 15 is partially formed between the spacer plate 2 and the partition plate 1 of the connected body 18. To adjust the height corresponding to this thickness, a height adjustment tape 16 may be applied to the portion of the flow path change portion 6 without the bonding tape 15.

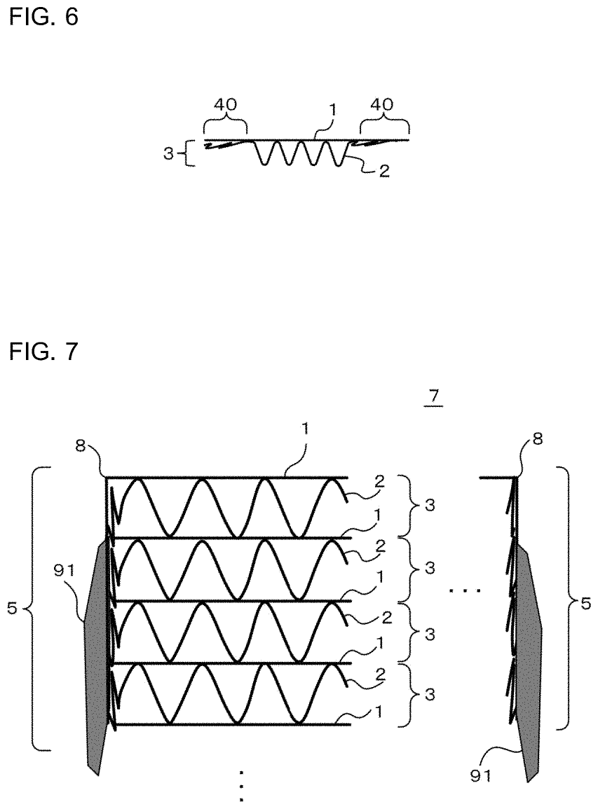

A method for manufacturing a heat exchange element according to Embodiment 1 will be described with reference to FIGS. 5 and 6. The spacer plate 2 having a corrugated shape in cross section is formed by pressing a pulp material made of cellulose fibers, a resin plate, or a metal plate, using a corrugated pressing machine, or gears. Then, adhesive is applied to the tips of the corrugations of the spacer plate 2 by an adhesive applicator. Then, the partition plate 1 is attached to the portions of the spacer plate 2 to which adhesive is applied, and then is dried, so that the partition plate 1 and the tips of the corrugations of the spacer plate 2 are bonded. Then, the partition plate 1 and the spacer plate 2 bonded together are cut into a rectangle by Thomson die-cutting or by using a cutter to form the heat transfer body 3 of the countercurrent portion 7 (heat transfer body forming step).

FIG. 5 illustrates the partition plate 1 and the spacer plate 2 of the heat transfer body 3 bonded to each other, in the heat exchange element 10 according to Embodiment 1. As illustrated in FIG. 5, the heat transfer body 3 has the shape of a single face corrugated board. This brings about an advantage that, by bonding the partition plate 1 and the spacer plate 2, the partition plate 1 having low rigidity is kept flat. The ends of the partition plate 1 of the heat transfer body 3 and the corrugated spacer plate 2 of the heat transfer body 3 are aligned.

The partition plate 1x and the spacer plate 2y bonded together in the same manner as illustrated in FIG. 5 are cut into an isosceles triangle by Thomson die-cutting or by using a cutter to form the heat transfer body 3x of the flow path change portion 6. The partition plate 1y and the spacer plate 2y bonded together are cut into an isosceles triangle by Thomson die-cutting or by using a cutter to form the heat transfer body 3y of the flow path change portion 6.

Then, the bonding tape 15 is applied to the base of the isosceles triangle of each heat transfer body 3x. The same bonding tape 15 is applied to two of the sides of the rectangle of the partition plate 1 of the heat transfer body 3 located on the inflow port or the outflow port, so as to extend thereon. In this manner, the connected body 17 including the heat transfer body 3 and the heat transfer bodies 3x is formed. Similarly, the bonding tape 15 is applied to the base of the isosceles triangle of each heat transfer body 3y. The same bonding tape 15 is applied to two of the sides of the rectangle of the partition plate 1 of the heat transfer body 3 located on the inflow port or the outflow port, so as to extend thereon. In this manner, the connected body 18 including the heat transfer body 3 and the heat transfer bodies 3y is formed.

Then, both ends of the portion where the partition plate 1 and the spacer plate 2 of the heat transfer body 3 are pressed and flattened by a roller or a pressing machine to form bent portions 40 (flattening step). FIG. 6 illustrates the partition plate 1 and the spacer plate 2 of the heat transfer body 3 with both ends pressed, in the heat exchange element 10 according to Embodiment 1.

Then, the connected body 17 including the heat transfer body 3 and the connected body 18 including the heat transfer body are alternately stacked such that corrugation directions of the spacer plates 2 are aligned (stacking step).

Then, the portions in each of which the partition plate 1 and the spacer plate 2 are overlaid, that is, the bent portions 40 are bent downward (bending step). The starting point of the bend of each bent portion 40 is defined as a bent corner 8.

Then, the end portions defined by bending the portions in each of which the partition plate 1 and the spacer plate 2 are overlaid, that is, the bent portions 40 that are bent in the bending step are bonded by the bonding unit 9 (for example, a seal material or a bonding tape) to form the side surface 5 (bonding step).

Each bent portion 40 is bent toward the bent corner 8 of the bent portion 40 of another heat transfer body 3. The length from the bent corner 8 to the end of the bent portion 40 is greater than the vertical distance between partition plates 1 of the heat transfer bodies 3. Therefore, when the bent portion 40 of the heat transfer body 3 is bent, the bent portion 40 is overlaid on the bent portion 40 of another heat transfer body to form the side surface 5.

As described above, in the heat exchange element 10 according to Embodiment 1, the side surface 5 is formed by the end portions defined by bending the portions in each of which the partition plate 1 and the spacer plate 2 are overlaid. As a result, the side surface 5 of the heat exchange element 10 and the outside of the heat exchange element 10 are separated by two plates. Therefore, heat insulation between the flow paths of the heat exchange element 10 and the outside air is improved, and heat exchange between the fluid in the flow paths of the heat exchange element 10 and the outside air is reduced. This brings about an advantage that the heat exchange element 10 with improved heat exchange efficiency is obtained.

Further, in the heat exchange element 10 according to Embodiment 1, each spacer plate 2 forming the side surface 5 has a plurality of folds. Each fold of the spacer plate 2 forming the side surface 5 overlaps another portion of the spacer plate 2 forming the side surface 5. Therefore, as compared to the case where spacer plate 2 forming the side surface 5 has a planar shape, the spacer plate 2 forming the side surface 5 has a thickness corresponding to the overlapped portion. As a result, heat insulation between the flow paths of the heat exchange element 10 and the outside air is further improved, and heat exchange between the fluid in the flow paths of the heat exchange element 10 and the outside air is further reduced. This brings about another advantage that the heat exchange element 10 with further improved heat exchange efficiency is obtained.

Further, in the heat exchange element 10 according to Embodiment 1, the portions of the partition plates 1 and the spacer plates 2 forming the side surface 5 are bonded by the bonding unit 9. As a result, the flow paths formed in the layers of the heat transfer bodies 3 of the countercurrent portion 7 are more tightly sealed against the outside of the heat exchange element 10. This brings about another advantage that the heat exchange element capable of further reducing leakage of fluid is obtained.

Specifically, when no treatment is applied to the side surface of a countercurrent portion as in the case of the heat exchange element of Patent Literature 1, a total of 16% of fluid leaks from the entire heat exchange element. In the case where the side surface is tightly sealed by applying a seal material thereto, the amount of fluid leaked is reduced to a total of 3%. Meanwhile, when the partition plates and the spacer plates forming the side surface 5 are bonded by the bonding unit 9 as in the case of the heat exchange element 10 of Embodiment 1, the amount of seal material used is reduced to ⅙ compared to the case where tight sealing against fluid leakage is implemented by applying a seal material, and the amount of fluid leaked is reduced to a total of 3%, which is substantially the same as that in the case where tight sealing is implemented by applying a seal material.

Further, when a heat exchange element is formed by stacking a plurality of heat transfer bodies as in the case of the heat exchange element of Patent Literature 1, a partition plate of a heat transfer body is in contact at its upper surface with the ends of a spacer plate of a heat transfer body of another layer, so that a load is applied thereon. If the heat exchange element of Patent Literature 1 and the heat exchange block of Patent Literature 2 are installed in a high humidity environment, the partition plate are softened, so that the partition plate sinks and the spacer plate abutting thereon may dig therein. Consequently, the flow path defined by the partition plate is narrowed, which hinders smooth flow of the fluid. This may result in an increase in the power required for driving the fan for sending the fluid.

In the heat exchange element 10 according to Embodiment 1, the side surface 5 is formed by bonding the overlapping plurality of partition plates 1 and spacer plates 2 with the bonding unit 9, so that the side surface 5 is turned to be a rigid planar surface. Accordingly, the countercurrent portion 7 is supported by the side surfaces 5, so that the partition plate 1 is prevented from sinking, and the spacer plate 2 abutting thereon is prevented from digging therein. This brings about another advantage that power for driving the fan for sending fluid is not increased, and power is not wasted.

Note that each spacer plate 2 forming the side surface 5 of the heat exchange element 10 of Embodiment 1 may have a planar shape.

### Embodiment 2

Hereinafter, the configuration of a heat exchange element 10 according to Embodiment 2 will be described with reference to FIG. 7. FIG. 7 is a cross-sectional view taken along A-A′ of a countercurrent portion 7 of the heat exchange element 10 according to Embodiment 2. The heat exchange element 10 of Embodiment 2 is different that the partition plate 1 and the spacer plate 2 are made of mixed paper in which thermally-fusible chemical fibers, such as polyethylene and polyethylene terephthalate, are mixed throughout to have thermal fusibility. In the mixed paper, the chemical fibers may be locally mixed, instead of being mixed throughout. Alternatively, the partition plate 1 and the spacer plate 2 may be made of a sheet containing pulp fibers as a base material and coated with thermally-fusible hot-melt adhesive or adhesive such as vinyl acetate. The configuration except the above is the same as that of the heat exchange element 10 of Embodiment 1.

In the following, a method for manufacturing the heat exchange element 10 according to Embodiment 2 will be described. The method for manufacturing the heat exchange element 10 of Embodiment 2 is similar to the method for manufacturing the heat exchange element 10 of Embodiment 1. However, the method of Embodiment 2 is different from the method of Embodiment 1 in that each of the partition plates 1 and the spacer plates 2 is made of mixed paper in which thermally-fusible chemical fibers such as polyethylene and polyethylene terephthalate are mixed, and the partition plates 1 and the spacer plates 2 are fused to form a thermally-fused portion 91 by thermocompression bonding using an iron or a trowel (thermocompression bonding step) when bonding the end portions defined by bending the portions in each of which the partition plate 1 and the spacer plate 2 are overlaid, that is, the bent portions 40 to each other.

As described above, the heat exchange element 10 of Embodiment 2 achieves the same advantages as those achieved by the heat exchange element 10 of Embodiment 1. Moreover, when bonding the end portions defined by bending the portions in each of which the partition plate 1 and the spacer plate 2 are overlaid, that is, the bent portions 40 to each other, the bonding unit 9 of Embodiment 1 is not needed. Therefore, the step of applying a seal material or applying a tape is eliminated. This brings about another advantage that the productivity is further improved.

The rigidity of the thermally-fused portion 91 of the heat exchange element 10 of Embodiment 2 is increased when cooled to room temperature, so that the side surface 5 is turned to be a rigid planar surface. Accordingly, the countercurrent portion 7 is supported by the side surfaces 5 having the thermally-fused portions 91, so that the partition plate 1 is prevented from sinking, and the spacer plate 2 abutting thereon is prevented from digging therein. This brings about another advantage that power for driving the fan for sending fluid is not increased, and power is not wasted.

Further, since the thermally-fused portion 91 is disposed on the side surface 5 of the heat exchange element 10, heat insulation between the outside of the of the heat exchange element 10 and the inside of the flow paths is further improved by the thickness of the thermally-fused portion 91, and heat transfer between fluid in the flow paths of the heat exchange element 10 and the outside air is further reduced. Therefore, a decrease in heat exchange efficiency is further reduced. This brings about an advantage that the heat exchange element 10 with further improved heat exchange efficiency is obtained.

### Embodiment 3

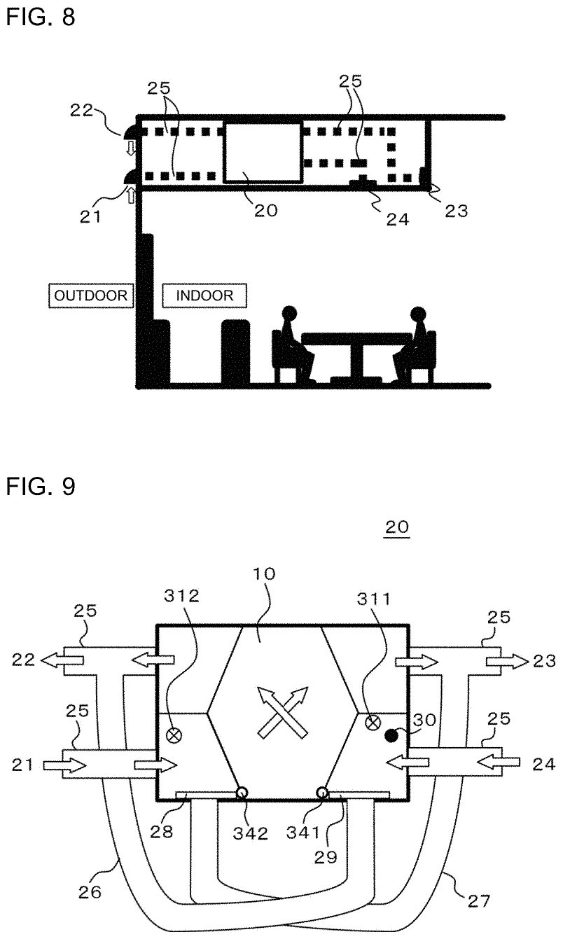

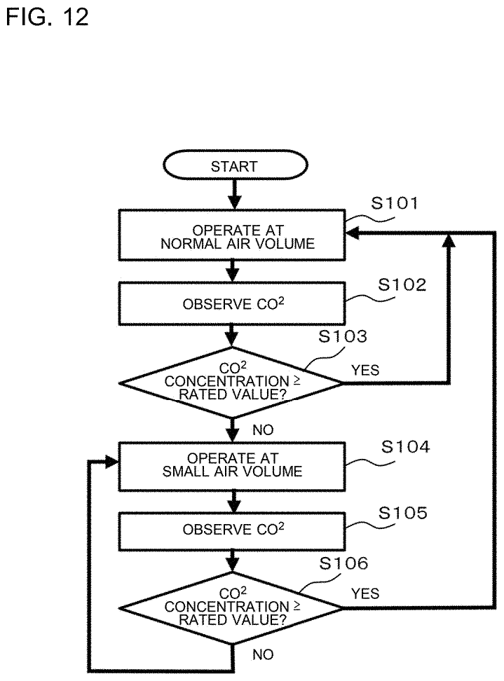

In Embodiment 3, the configuration and operation of the heat exchange ventilator 20 including the heat exchange element 10 of Embodiment 1 will be described with reference to FIGS. 8 to 13. FIG. 8 is an external view illustrating the heat exchange ventilator installed in a room according to Embodiment 3. The heat exchange ventilator 20 is one type of air-conditioning apparatuses, and is a ventilator having a ventilation function of supplying the outdoor air into the room and exhausting the indoor air to the outside, and a function of reducing the energy load on a temperature adjustment device such as an air-conditioning device by recovering heat from the exhaust air and transferring the heat to the supply air.

In Embodiment 3, the heat exchange ventilator 20 is accommodated in the ceiling of the room. In many residences, from the standpoint of the appearance of the room, air-conditioning equipment is all accommodated in the ceiling as illustrated in FIG. 8. Generally, in the case of installing the equipment in the ceiling, a larger installation space can be secured as compared to the case of installing the equipment in the room. As illustrated in FIG. 8, an outdoor air-inlet 21 as a hole for introducing the outdoor air and an outdoor air-outlet 22 as a hole for exhausting air to the outside are provided in the outdoor wall surface. Also, an indoor air-inlet 23 as a hole for introducing air into the room and an indoor air-outlet 24 as a hole for exhausting the indoor air are provided in the ceiling of the room. The outdoor air-inlet 21 is connected to the indoor air-inlet 23, and the outdoor air-outlet 22 is connected to the indoor air-outlet 24, through ducts 25 via the heat exchange ventilator 20 including the heat exchange element 10.

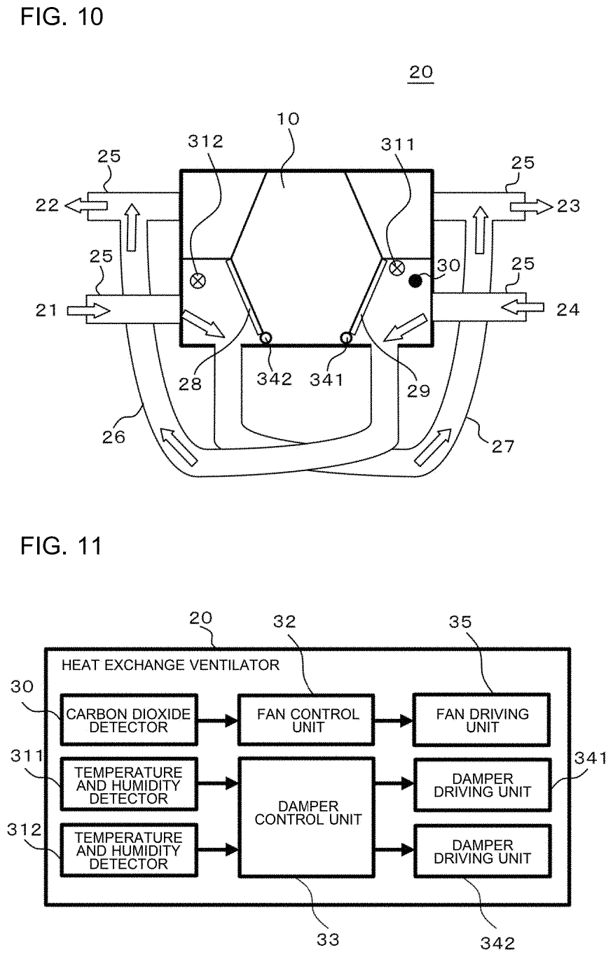

FIGS. 9 and 10 are internal configuration diagrams of the heat exchange ventilator according to Embodiment 3. As illustrated in FIG. 9, the heat exchange ventilator 20 includes the heat exchange element 10, and transfers heat as indoor air and outdoor air pass through the heat exchange element 10. The heat exchange ventilator 20 includes two fans (not illustrated) for sending air from outdoors to indoors, and from indoors to outdoors, and supplies air to and exhausts air from the room by operating the fans. The heat exchange ventilator 20 further includes bypass air paths 26 and 27, and dampers 28 and 29 for switching the air path, and is capable of switching the air path.

As described above, the heat exchange element 10 has the inflow port 11 for the first fluid, the outflow port 12 for the first fluid, the inflow port 13 for the second fluid, and the outflow port 14 for the second fluid. When mounting the heat exchange element 10 in the heat exchange ventilator 20, the inflow port 11 for the first fluid is coupled to the duct 25 connected from the outdoor air-inlet 21, and the outflow port 12 for the first fluid is coupled to the duct 25 connected to the indoor air-inlet 23, for example. Also, the inflow port 13 for the second fluid is coupled to the duct 25 connected from the indoor air-outlet 24, and the outflow port 14 for the second fluid is coupled to the duct 25 connected to the outdoor air-outlet 22.

In the heat exchange ventilator 20, a carbon dioxide detector 30 (carbon dioxide sensor) that detects carbon dioxide is disposed in the vicinity of the inflow port through which the exhaust air from the room enters from the indoor air-outlet 24. A temperature and humidity detector 312 (temperature and humidity sensor) is disposed in the vicinity of the inflow port of the heat exchange ventilator 20 through which the intake air from the outside enters from the outdoor air-inlet 21. A temperature and humidity detector 311 (temperature and humidity sensor) is disposed in the vicinity of the inflow port through which the exhaust air from the room enters from the indoor air-outlet 24.

FIG. 9 illustrates the flow of air as fluid in the heat exchange element 10 caused by the dampers 28 and 29. FIG. 10 illustrates the flow of air as fluid in the heat exchange element 10 blocked in response to switching of the air path by the dampers 28 and 29.

FIG. 11 is a functional configuration diagram of the heat exchange ventilator 20 according to Embodiment 3. A fan control unit 32 transmits an instruction indicating the air volume to a fan driving unit 35, based on the concentration of carbon dioxide contained in the exhaust air detected by the carbon dioxide detector 30. The fan driving unit 35 drives the fans (not illustrated), based on the air volume indicated by the fan control unit 32. The operation of the fan control unit 32 will be described below.

A damper control unit 33 transmits an instruction indicating the orientation of the dampers to a damper driving unit 341 and a damper driving unit 342, based on the indoor and outdoor temperatures and humidity detected by the temperature and humidity detector 311 and the temperature and humidity detector 312. The damper driving unit 341 drives the damper 29 to the orientation indicated by the damper control unit 33. The damper driving unit 342 drives the damper 28 to the orientation indicated by the damper control unit 33. The operation of the damper control unit 33 will be described below.

FIG. 11 is a flowchart illustrating the operation of the fan control unit 32 of the heat exchange ventilator 20 according to Embodiment 3. First, the fan control unit 32 instructs the fan driving unit 35 to drive the fans at a normal air volume (S101). Thereafter, the process proceeds to S102. The normal air volume is, for example, 500 m3/h.

Then, the fan control unit 32 receives a concentration of carbon dioxide contained in the exhaust air detected by the carbon dioxide detector 30 (S102). Thereafter, the process proceeds to S103.

Then, the fan control unit 32 determines whether the concentration of carbon dioxide contained in the exhaust air of the room is greater than or equal to a rated value (S103). If the concentration of carbon dioxide contained in the exhaust air of the room is greater than or equal to the rated value (YES in S103), the process returns to S101 in which the fan control unit 32 continues to instruct the fan driving unit 35 to drive the fans at the normal air volume (S101).

If the concentration of carbon dioxide contained in the exhaust air of the room is less than or equal to the rated value (NO in S103), the process proceeds to S104 in which the fan control unit 32 instructs the fan driving unit 35 to drive the fans at a small air volume (S104). Thereafter, the process proceeds to S105. The rated value of the concentration of carbon dioxide is, for example, 200 ppm. If there are about 10 people in the room, the amount of carbon dioxide generated is small, and the carbon dioxide concentration in the room is less than or equal to 200 ppm. The small air volume is, for example, 210 m3/h.

Then, the fan control unit 32 receives a concentration of carbon dioxide contained in the exhaust air detected by the carbon dioxide detector 30 (S105). Thereafter, the process proceeds to S106.

Then, the fan control unit 32 determines whether the concentration of carbon dioxide contained in the exhaust air of the room is greater than or equal to a rated value (S106). If the concentration of carbon dioxide contained in the exhaust air of the room is greater than or equal to the rated value (YES in S106), the process returns to S101 in which the fan control unit 32 instructs the fan driving unit 35 to drive the fans at the normal air volume (S101).

If the concentration of carbon dioxide contained in the exhaust air of the room is less than or equal to the rated value (NO in S106), the process returns to S104 in which the fan control unit 32 continues to instruct the fan driving unit 35 to drive the fans at a small air volume (S104). By performing the operation described above, the fan control unit 32 reduces the fan power when the carbon dioxide concentration in the room is less than or equal to the rated value. This brings about an advantage that power consumption is reduced.

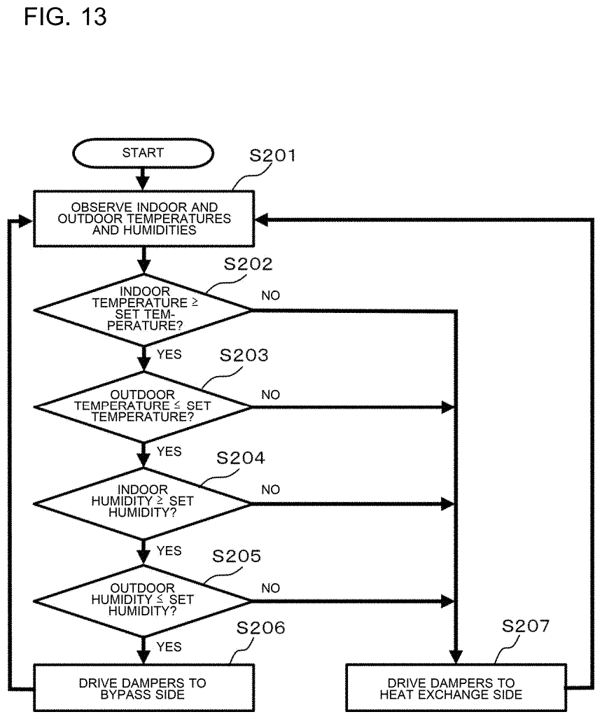

FIG. 13 is a flowchart illustrating the operation of the damper control unit 33 of the heat exchange ventilator 20 according to Embodiment 3. First, the damper control unit 33 receives an indoor air temperature, an outdoor air temperature, an indoor air humidity, an indoor air humidity, and an outdoor air humidity detected by the temperature and humidity detector 311 and the temperature and humidity detector 312 (S201). Thereafter, the process proceeds to S202.

Then, the damper control unit 33 determines whether the indoor air temperature is higher than or equal to a set temperature (S202). If the damper control unit 33 determines that the indoor air temperature is higher than or equal to the set temperature (YES in S202), the process proceeds to S203. If the damper control unit 33 determines that the indoor air temperature is not higher than or equal to the set temperature (NO in S202), the process proceeds to S207.

Then, the damper control unit 33 determines whether the outdoor air temperature is lower than or equal to a set temperature (S203). If the damper control unit 33 determines that the outdoor air temperature is lower than or equal to the set temperature (YES in S203), the process proceeds to S204. If the damper control unit 33 determines that the outdoor air temperature is not lower than or equal to the set temperature (NO in S203), the process proceeds to S207.

Then, the damper control unit 33 determines whether the indoor air humidity is higher than or equal to a set humidity (S204). If the damper control unit 33 determines that the indoor air humidity is higher than or equal to the set humidity (YES in S204), the process proceeds to S205. If the damper control unit 33 determines that the indoor air humidity is not higher than or equal to the set humidity (NO in S204), the process proceeds to S207.

Then, the damper control unit 33 determines whether the outdoor air humidity is lower than or equal to a set humidity (S205). If the damper control unit 33 determines that the outdoor air humidity is lower than or equal to the set humidity (YES in S205), the process proceeds to S206. If the damper control unit 33 determines that the outdoor air humidity is not lower than or equal to the set humidity (NO in S205), the process proceeds to S207.

In S206, the damper control unit 33 instructs the damper driving unit 341 and the damper driving unit 342 to drive the damper 28 and the damper 29 to change their orientations for bypassing the heat exchange element 10 as illustrated in FIG. 10. Thereafter, the process returns to S201. In the case where the indoor air temperature is higher than or equal to the set temperature and the outdoor air temperature is lower than or equal to the set temperature, there is no need to recover heat from the room by exchanging heat, so that it is preferable not to make ventilation air pass through the heat exchange element 10. For example, when the set temperature of the indoor air is 25 degrees C., the temperature and humidity detector 311 detects that the indoor air temperature is 30 degrees C. and that the outdoor air temperature is 20 degrees C. The detection information is transmitted to the separately provided damper control unit 33.

As a result of the air path switching, the damper 28 and the damper 29 block the inflow port 11 for the first fluid and the inflow port 13 for the second fluid in the heat exchange element 10, so that the supply air from the outside passes through a bypass air path 27, and the exhaust air from the room passes through a bypass air path 26. That is, an air path configuration is established where the supply air from the outside and the exhaust air from the room do not pass through the heat exchange element 10. As a result, the outdoor air with a temperature lower than that of the indoor air is directly introduced, so that the indoor temperature is lowered.

In S207, the damper control unit 33 instructs the damper driving unit 341 and the damper driving unit 342 to drive the damper 28 and the damper 29 to change their orientations such that the heat exchange element 10 performs heat exchange as illustrated in FIG. 9. Thereafter, the process returns to S201. For example, when the indoor air temperature is lower than or equal to the set temperature and the outdoor air temperature is higher than or equal to the set temperature, the dampers 28 and 29 are driven such that the supply air from the outside and the exhaust air from the room pass through the heat exchange element 10.

Although the heat exchange ventilator 20 of Embodiment 3 includes the heat exchange element 10 of Embodiment 1, the heat exchange ventilator 20 may include the heat exchange element 10 of Embodiment 2.

The present disclosure is not limited to Embodiments 1 to 3. Embodiments may be freely combined with each other, and Embodiments may be partly modified or omitted, within the scope of the disclosure.

### REFERENCE SIGNS LIST

1, 1x, 1y partition plate 2, 2x, 2y spacer plate 3, 3x, 3y heat transfer body 40 bent portion 5 side surface 51 first flow path 52 second flow path 6 flow path change portion 7 countercurrent portion 8 bent corner 9 bonding unit 10 heat exchange element 11 inflow port for first fluid 12 outflow port for first fluid 13 inflow port for second fluid 14 outflow port for second fluid 15 bonding tape 16 height adjustment tape 17, 18 connected body 20 heat exchange ventilator 21 outdoor air-inlet 22 outdoor air-outlet 23 indoor air-inlet 24 indoor air-outlet 25 duct 26 bypass air path 27 bypass air path 28 damper 29 damper 30 carbon dioxide detector 311, 312 temperature and humidity detector 91 thermally-fused portion

1. A heat exchange element comprising:
a countercurrent portion including
a plurality of partition plates each having a planar shape, and
a plurality of spacer plates each having a corrugated shape in cross section,
the partition plates and spacer plates being alternately stacked such that corrugation directions of the spacer plates are aligned;
wherein a side surface of the countercurrent portion is formed of end portions defined by bending portions in each of which the partition plate and the spacer plate are overlaid.

2. The heat exchange element of claim 1,
wherein the portion of each of the spacer plates forming the side surface has a plurality of folds; and
wherein each of the folds of the spacer plate forming the side surface overlaps another portion of the spacer plate forming the side surface.

3. The heat exchange element of claim 1, wherein the portions of the partition plates and the spacer plates forming the side surface are bonded by a bonding unit.

4. The heat exchange element of claim 1, wherein each of the partition plates and the spacer plates is made of a thermally-fusible unit.

5. A heat exchange ventilator comprising:
the heat exchange element of claim 1;
wherein the heat exchange element causes heat exchange to be performed between fluid suctioned from an outdoor air-inlet and exhausted through an indoor air-outlet and fluid suctioned from an indoor air-inlet and exhausted through an outdoor air-outlet.

6. A method for manufacturing a heat exchange element comprising:
a heat transfer body forming step of forming a heat transfer body having a rectangular shape in plan view, by bonding a partition plate having a planar shape and a spacer plate having a corrugated shape in cross section;
a stacking step of stacking plural of the heat transfer bodies such that corrugation directions of the spacer plates are aligned; and
a side surface forming step of bending portions in each of which the partition plate and the spacer plate are overlaid.

7. The method for manufacturing a heat exchange element of claim 6, further comprising:
a flattening step of pressing and flattening the portions in each of which the partition plate and the spacer plate are overlaid, before stacking the heat transfer bodies in the stacking step.

8. The method for manufacturing a heat exchange element of claim 6, further comprising:
a bonding step of bonding end portions defined by bending the portions in each of which the partition plate and the spacer plate are overlaid, by a bonding unit.

9. The method for manufacturing a heat exchange element of claim 6, further comprising:
a thermocompression bonding step of bonding end portions defined by bending the portions in each of which the partition plate and the spacer plate are overlaid, through thermocompression, each of the partition plates and the spacer plates being made of a thermally-fusible unit.
